(19) United States
(12) Patent Application Publication
(10) Pub. No.: US 2014/0258672 A1
(43) Pub. Date: Sep. 11, 2014

(54) DEMAND DETERMINATION FOR DATA BLOCKS

(71) Applicant: MICROSOFT CORPORATION, Redmond, WA (US)

(72) Inventors: Andrew Herron, Redmond, WA (US); Robert Patrick Fitzgerald, Fall City, WA (US); Juan-Lee Pang, Redmond, WA (US)

(73) Assignee: MICROSOFT CORPORATION, Redmond, WA (US)

(21) Appl. No.: 13/791,299

(22) Filed: Mar. 8, 2013

(51) Int. Cl. G06F 12/02

(52) U.S. Cl. CPC G06F 12/0223
USPC 711/171

(57) ABSTRACT

The positioning a block of data within a storage hierarchy. For the given block of data, demand statistics are accumulated for each of multiple time periods by evaluating input/output operations on the block of data during the time period and assigning a resulting demand value to the time period for that time period. This is done for multiple time periods so that the accumulated demand for a given point of time may be calculated using the assigned demand values for the previous time periods. The accumulated demand may then be used to determine a level in the storage hierarchy that the block of data should be placed. This allows for the more in-demand memory blocks to be placed in higher in the storage hierarchy. Thus, the principles described herein allow for efficient use of computing resources.

### BACKGROUND

Computing systems obtain a high degree of functionality by executing software programs. Computing systems use storage hierarchies in order to store such software programs and other files. Lower levels generally have larger capacities, lower cost per bit, and lower performance. Higher levels generally have smaller capacities, higher cost per bit, and higher performance. Thus, a bottom tier might be constructed from one or more hard drivers. Higher up in the storage hierarchy might be one or more solid state drives. Yet further higher up might be constructed from emerging high performance technology.

Computing systems operate most efficiently when the most in demand blocks of data are located high in the storage hierarchy, wherein the lesser demanded blocks of data might be located lower in the storage hierarchy. There are various eviction algorithms that exist to determine when it is appropriate to evict a block of data from a higher level in the storage hierarchy to a lower level in the storage hierarchy. Likewise, there are various promotion algorithms that exist to determine when it is appropriate to promote a block of data from a lower level in the storage hierarchy to a higher level in the storage hierarchy. Thus, as eviction and promotion algorithms work on various blocks of data, a given block might move within the storage hierarchy dynamically responsive to dynamically changing demand for the block of data.

### BRIEF SUMMARY

At least some embodiments described herein relate to the positioning of a block of data within a storage hierarchy. For the given block of data, demand statistics are accumulated for each of multiple time periods by evaluating input/output operations on the block of data during the time period and assigning a resulting demand value for that time period. This is done for multiple time periods so that the accumulated demand for a given point of time may be calculated using the assigned demand values for the previous time periods. The accumulated demand may then be used to determine a level in the storage hierarchy that the block of data should be placed. This allows for the more in-demand memory blocks to be placed in higher in the storage hierarchy. Thus, the principles described herein allow for efficient use of computing resources.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a computing system in which some embodiments described herein may be employed;

FIG. 2 illustrates a system in which the principles described herein may be employed by way of example, and which includes blocks of data that are positioned somewhere within a storage hierarchy; and

FIG. 3 illustrates a flowchart of a method for positioning a block of data within a storage hierarchy.

### DETAILED DESCRIPTION

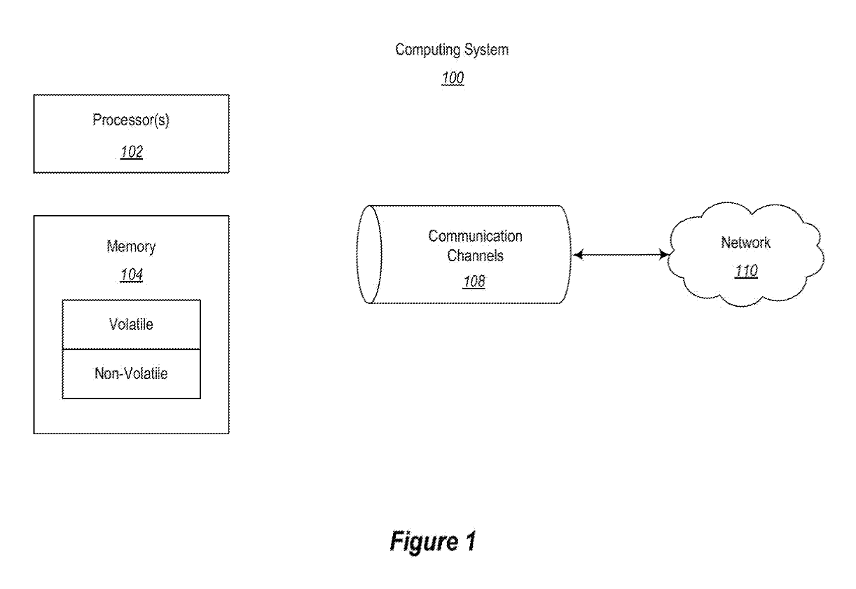

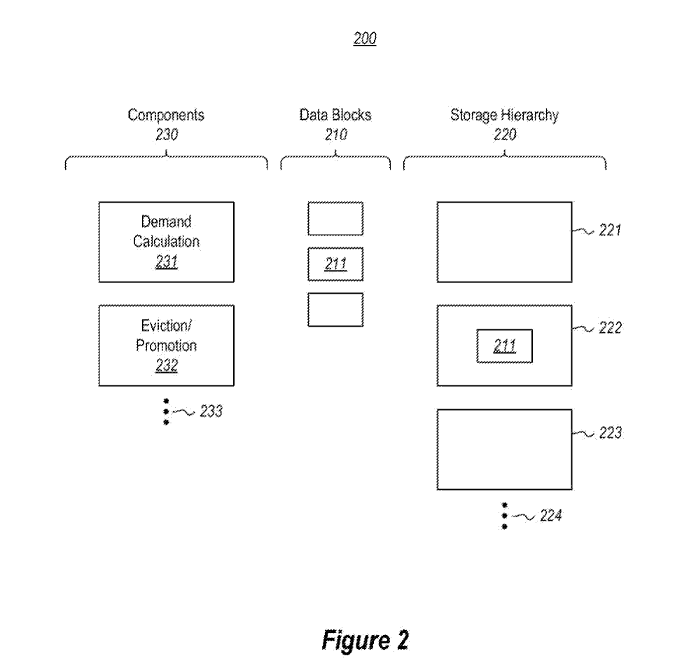

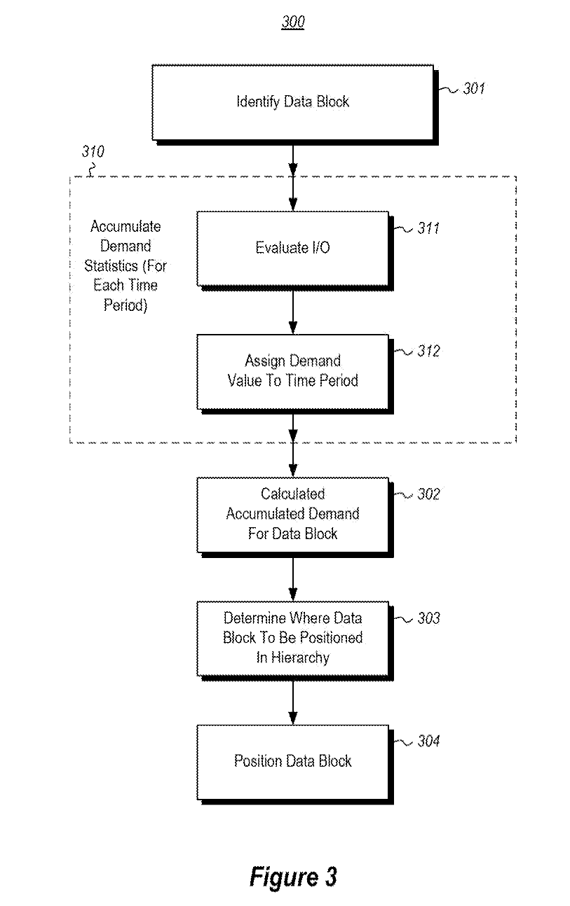

In accordance with embodiments described herein, the positioning of a block of data within a storage hierarchy is described. For the given block of data, demand statistics are accumulated for each of multiple time periods by evaluating input/output operations on the block of data during the time period and assigning a resulting demand value for that time period. This is done for multiple time periods so that the accumulated demand for a given point of time may be calculated using the assigned demand values for the previous time periods. The accumulated demand may then be used to determine a level in the storage hierarchy that the block of data should be placed in. This allows for the more in-demand memory blocks to be placed higher in the storage hierarchy. Thus, the principles described herein allow for efficient use of computing resources. Some introductory discussion of a computing system will be described with respect to FIG. 1. Then, the principles of positioning blocks within a storage hierarchy will be described with respect to FIGS. 2 and 3.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 illustrates a system 200 in which the principles described herein may be employed by way of example. The system 200 includes blocks of data 210 that are positioned somewhere within a storage hierarchy 220. The system also includes components 230 that execute logic to determine where the blocks of data 210 should be positioned within the storage hierarchy 220. Each of these elements of the system 200 will now be described in further detail.

The blocks of data 210 may be fixed sized data blocks, or blocks of different sizes, or a combination of fixed size and variable size blocks. For instance, suppose the system 200 operates within the file system. In that case, the data blocks might be fixed size file portions of a particular size (e.g., as an example only, perhaps one megabyte). When a file is below that particular size, the data block may include the entire file and thus be less that the particular size. Thus, in that case, the set of data blocks 210 includes fixed size blocks when those data blocks are portions of a file, or variable size blocks when those data blocks are an entire file.

That said, this is just an example, the principles described herein are not dependent on the data blocks being visible at the file system level. For instance, the system 200 may operate above the file system level at the caching level of the computing system. In that case, the blocks of data might be blocks of data as they are visible to the caching system. The system 200 may also operate close to the physical level in which case the data blocks might be segments of data as visible to those lower levels. Accordingly, the principles described herein are not limited to operation at the file system level. Nevertheless, for example purposes only, the principles described herein may occasionally reference the data blocks as being a file portion, or a file, which are data blocks that are visible to the file system.

Each of the blocks of data 210 are located within a level of the storage hierarchy 220. The storage hierarchy is any storage hierarchy that includes two or more levels. For instance, in FIG. 2, for example purposes only, the storage hierarchy 220 is illustrated as including three levels, a high level 221, a middle level 222, and a low level 223. The storage hierarchy is characterized in that the higher the level in the hierarchy, the more costly (per bit) it is to store data.

Although the term “storage” is used to modify the term “hierarchy”, this should not be read as requiring non-volatility in all levels of the storage hierarchy 220. It is common for the higher levels of the storage hierarchy to in fact be volatile. For instance, Random Access Memory (RAM) is traditionally volatile, though not required. In one embodiment, as an example only, the high level 221 may be flash memory, the low level 223 might be solid-state disk or mechanical disk, and the middle level 222 might be some level in-between. As another example, in which all of the levels are non-volatile, the high level 221 might be comprised of byte-addressable Non-Volatile Memory (NVM) such as MRAM, RRAM, STT-RAM, FERAM, and so forth, or DRAM backed with NAND or other NVM technology. The middle level 222 might be a solid state drive, and the lower level 223 might be a disk drive. However, these are just examples. The ellipses 224 represent that the principles described herein are not limited to the number of levels within the storage hierarchy 220 so long as there is at least two such levels. For discussion purposes, one of the data blocks 210 (labeled data block 211) is located within the middle level 222 of the storage hierarchy 220. The components 230 include several executable modules including, for example, a demand calculation component 231 and an eviction/promotion component 232. The ellipses 233 represents that there is flexibility in terms of how many components contribute to the functionality described below as being attributable to the demand calculation component 231 and the eviction/promotion component 232. The components 231 and 232 may be executed by one or more processors (e.g., processor 102 of FIG. 1) of a computing system (e.g., computing system 100) executing computer-executable instructions stored on one or more computer-readable storage media that compose a computer program product. The operation of the components 230 will be described with respect to FIG. 3.

FIG. 3 illustrates a flowchart of a method 300 for positioning a block of data within a storage hierarchy. The method 300 may be performed for each of multiple data blocks. For illustrative purposes, the method 300 will be described with respect to the system 200 of FIG. 2, in which the components 230 determine a demand associated with the data block 211, and determine whether or not to promote the data block 211 (which would involve elevating the data block 211 from the middle level 222 to the high level 221 of the storage hierarchy 220), and whether or not to evict the data block 211 (which would involve evicting the data block 211 from the middle level 222 to the low level 223 of the storage hierarchy 220).

The method 300 is initiated by identifying a data block that is to be evaluated for promotion and/or eviction (act 301). With reference to FIG. 2, and in the example described herein, that identified data block is the data block 211, which is currently in the middle level 222 of the storage hierarchy 220.

The method 300 includes accumulating demand statistics for the data block over multiple time periods (act 310). The content of act 310 in FIG. 3 is performed for each time period. In one embodiment, the time periods may be relatively small, perhaps as small as just a few seconds. The accumulation of the demand statistics may be performed by, for example, the demand calculation component 231 of FIG. 2.

In particular, for the given data block being evaluated by the method 300, and for each time period, the demand calculation component 231 evaluates input/output operations on the data block of data during the corresponding time period (act 311). Based on this evaluation, the demand calculation component 231 assigns a demand value to the time period for that data block (act 312). As an example, suppose that the time period were perhaps 5 seconds. The demand values might be accumulated over a period of a week perhaps. Several examples and variations of this process will now be described.

In a first example, the evaluation of the input/output operations (act 311) might simply be determining whether an input/output operation occurred on the block of data during the time period. In the more general case, the assignment of the demand value (act 312) might assign a higher demand value (e.g., a 1—one) to the combination of the data block and time period if the input/output operation occurred on the block of data during the time period, and assign a lower demand value (e.g., 0—zero) for the combination and of the data block and time period if the input/output operation did not occur on the block of data during the time period. This first example will be referred to as the “yes/no example” hereinafter.

In a second example, the demand value for a given data block and time period is a count of the input/output operations that occur on the data block during that time period. In the case, the evaluation of the input/output operations (act 311) for a given combination of data block and time period might involve simply counting the number of input/output operations on the block of data during the time period. The assigned demand value might then be a function of the count, and might even be equal to the count itself. This second example will be referred to hereinafter as the “count example”.

There are a number of variations on the yes/no example and the count example. For instance, the demand value assigned for a given data block and time period might also be a function of a size of the block of data. For instance, perhaps the smaller the block of data, the higher the demand value for a given occurrence of input/output operations on the block of data during the time period. As an example, suppose that the typical size of a data block is one megabyte, in the case of the data block representing a portion of a file that is larger than one megabyte, but that there exists a file that is only one hundred kilobytes that is represented by its own data block. If ten input/output operations were to occur on the one megabyte data block for a given time period, and if only one input/output operation were to occur on the one hundred kilobyte data block, then both of these data blocks are experiencing the same per-byte demand. Accordingly, there might be some adjustment for the smaller size of the one hundred kilobyte data block (such as the demand value being multiplied by ten).

Another variation on the yes/no example and the count example would be to have the demand value be some function of a size of data exchanged during the evaluated input/output operations. For instance, larger exchanges of data might warrant adjustment of the demand value upwards (or downwards), whereas smaller exchanges of data might warrant adjustment of the demand value downwards (or upwards).

Another variation on the yes/no example and the count example would be to have the demand value be some function of a pattern of the input/output operations on the block of data during the time period. For instance, sequential input/output operations might be assigned a lower demand value than random access input/output operations.

As numerous demand values are to be calculated for numerous data blocks, there is some advantage to reduce the computational intensity of the calculation of the demand values. A good balance might be to perform the yes/no example above and use just the data block size adjustment for smaller data blocks. However, as computational resources become less expensive, other calculation mechanisms may become more advantageous.

Referring again to FIG. 3, using the accumulated demand statistics (obtained in act 310), the method 300 then calculates an accumulated demand for the data block for a given time after the multiple time periods corresponding to the accumulated demand values have completed (act 302). A number of mechanisms for doing this will be described further below, after the remainder of FIG. 3 is described. In FIG. 2, the demand calculation component 231 may generate this accumulated demand as an output that is fed to the eviction/promotion component 232.

The eviction/promotion component 232 determines a level in a storage hierarchy to store the block of data based on the calculated accumulated demand for the block of data (act 303). The eviction/promotion component 232 then positions that data block in the determined level of the storage hierarchy (act 304).

For instance, consider the case in which method 300 operates on the data block 211 of FIG. 2, in which case, the data block 211 is currently positioned within the middle level 222 of the storage hierarchy 220. If the calculated accumulated demand is above a certain first threshold, the data block 211 might be promoted to the higher level 221 of the storage hierarchy 220. If the calculated accumulated demand is below a certain second threshold, the data block 211 might be evicted to the lower level 223 of the storage hierarchy 220. If the accumulated demand is between the first and second thresholds, the data block 211 might simply stay put for now in the middle level 222 of the storage hierarchy 220.

Note that there might be some hysteresis built in to the decision to promote and evict a data block. That is, the accumulated demand threshold corresponding to a decision to promote a data block from a first layer to a second layer might be higher than the accumulated demand threshold corresponding to a decision to evict the data block from the second layer back to the first layer.

Thus, a mechanism for determining an accumulated demand is described. As further described, once the accumulated demand for a data block is determined, the mechanism may then act on that accumulated demand to evict or promote a data block within a storage hierarchy. The principles described herein are not limited to a particular one mechanism for calculating accumulated demand.

In one approach for calculating accumulated demand, the time periods for a given data block are cluster into larger groups of time periods. Periodically, at sequential time periods equal to the aggregated time period of a larger group, the oldest group of time periods is discarded from being included in the calculation of the accumulated demand. For instance, suppose that each time period is 5 seconds. The time periods might be clustered into groups totally 6 hours (which would result in 4320 time periods per grouping). Every 6 hours or so, once the oldest group of 6 hours has reached a certain again (say perhaps one week) the oldest group of 6 hours would be relegated to irrelevancy (e.g., discarded) in any future calculation of accumulated demand for that data block. Note that the 5 second interval for the smaller time period, and the six hour time period for the larger time period is just an example. The larger time period might be, for example, a day, or any other value without departing from the principles described herein.

In this approach, perhaps in at least some cases, assigned demand values for time periods that are older are given less of a weighting in the calculation of accumulated demand that assigned demand values for a more recent period of time. This might be a discrete reduction. For instance, in the example above in which demand values for the prior week are used to calculate accumulated demand, perhaps the most recent three days of demand values are given full value, whereas demand values from four through seven days ago are given a half weighting.

A more continuous approach to reducing the weighting of a demand value over time is to apply a decaying function to the assigned demand for a given time period so that the assigned demand weighs less and less into the calculated accumulated demand as time moves forward. For instance, suppose that the demand value for each time period is to have a certain half-life. Mathematically, it will then be possible to determine how long it should take for the demand value to lose 1/512^{th} (read “one five hundred and twelfth”) of its value. It is a computationally efficient operation to decay a value by 1 over some amount “n” if n can be expressed in the form of 2^{x}, where x is any positive integer (512 can be expressed as 2⁹). Accordingly, every so often, the decaying operation is applied to the demand value to ensure the desired half-life. In this case, perhaps the older time periods are never expressly removed from consideration in the calculation of accumulated demand. Instead, older demand values simply decay into less and less relevancy.

Another mechanism for reducing the amount of storage associated with storing each of these demand values is to represent all prior demand values as a single prior accumulated statistic. For instance, in the case of having demand values hold relevance for one week, the accumulated demand statistic might be a running average of the prior demand values for that week. When a new demand value is obtained for a given time period, prior to (or after) adding that new demand value to the accumulated statistic, the accumulated demand might be adjusted by offsetting the accumulated demand to account for removal of an oldest time period in the plurality of time periods.

For instance, suppose that there is a yes/no example in which the demand statistics were accumulated for 5 days in time periods of 6 hours. 6 hours is very long as the time period might usually be only a few seconds. However, the use of 6 hours results in an easier computation for purposes of illustrating this example. This would mean that there are 20 six hour periods used in the calculation of accumulated demand. Now suppose that accumulated demand statistic is 20 percent, meaning that 20 percent of the time periods (i.e., 4 in this example) involved an input/output operation to the corresponding data block.

Now suppose that a new 6 hour time period has just concluded and an input/output operation has been observed on that data block during that 6 hour period. In this case, a new time period (representing 100 percent since an input/output operation did occur during that time period) is appended to the front of the time period, and an old time period (represent the previous average of 20 percent) is removed from the other end of the time span. The result is 19 time segments having a value of 20 percent, and 1 having a value of 100 percent. The new accumulated statistic then becomes 24 percent. Note that this might not be a true average, since the oldest time period either did or did not have an input/output operation that occurred during that time period. However, the value is still treated as 20 percent. Thus, the accumulated average statistic might not represent the actual average. However, the representation is close enough to have the effect of roughly estimating demand, without requiring storage space to store each and every demand value. Furthermore, computational resources are preserved since the computation deals with the accumulated statistic and the new demand value, and do not have to deal with numerous individual demand values for each data block.

An alternative method to representing the demand statistics for a block would be to use the average time between accesses of that block. A shorter average time between accesses would mean a higher demand statistic while a longer average time between accesses would mean a lower demand statistic. These averages could be calculated by first determining the elapsed time that has occurred since the time the block was first accessed. This elapsed time (since the first access of the block) is divided by the sum of all demand values accumulated for that block during the elapsed time. Since the average time between accesses alone does not differentiate a piece of a file that has been actively accessed for a longer period of time versus a file that is just recently becoming actively accessed, relative demand statistics between blocks will also take into account total accumulated demand values. In other words, the list of descending demand statistics will be sorted first by total accumulated demand values, highest to lowest, and then by average time between access, lowest to highest.

One drawback of this method is that it can favor blocks that have been historically frequently accessed making it hard for blocks that are just now getting more frequently accessed to be recognized as a candidate for promotion. In order to deal with this situation, there might be a might be a maximum time period for storing accumulated demand values. This would work by discarding a demand value if the elapsed time since the block was first accessed exceeded the maximum time period. The amount of demand values discarded will be the total accumulated demand values minus the elapsed time divided by the current average time between accesses. This works because it reduces the amount of ground block just now being frequently accessed will have to make up before being considered in high demand.

Accordingly, effective mechanisms for calculating demand associated with data blocks are described. Such calculated demand may be used to, for example, evict or promote a data block within a storage hierarchy. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method for positioning a block of data within a storage hierarchy, the method comprising:
an act of identifying a block of data;
an act of accumulating demand statistics for the block of data over a plurality of time periods by performing the following for each of the plurality of time periods:
an act of evaluating input/output operations on the block of data during the time period;
an act of assigning a demand value to the time period based on the act of evaluating input/output operations on the block of data during the time period;
an act of calculating an accumulated demand for the block of data associated with a given point in time by using the accumulated demand statistics;
an act of determining a level in a storage hierarchy to store the block of data based on the calculated accumulated demand for the block of data; and
an act of positioning in the block of data in the determined level of the storage hierarchy.

2. The method in accordance with claim 1,
wherein the act of evaluating input/output operations on the block of data during the time period comprises the following for at least one of the plurality of time periods: an act of determining whether an input/output operation occurred on the block of data during the time period.

3. The method in accordance with claim 2, wherein the act of assigning a demand value for the at least one of the plurality of time periods comprises an act of assigning a higher demand value for the time period if the input/output operation occurred on the block of data during the time period, and a lower demand value for the time period if the input/output operation did not occur on the block of data during the time period.

4. The method in accordance with claim 1,
wherein the act of evaluating input/output operations on the block of data during the time period comprises the following for at least one of the plurality of time periods: an act of counting the number of input/output operations on the block of data during the time period.

5. The method in accordance with claim 4, wherein the act of assigning a demand value for the at least one of the plurality of time periods comprises an act of assigning a demand value that is a function of the count of the number of input/output operations on the block of data during the time period.

6. The method in accordance with claim 1, wherein the act of assigning a demand value for at least one of the plurality of time periods comprises an act of assigning a demand value that is a function of a size of the block of data such that the smaller the block of data, the higher the demand value for a given occurrence input/output operations on the block of data during the time period.

7. The method in accordance with claim 1, wherein the act of assigning a demand value for at least one of the plurality of time periods comprises an act of assigning a demand value that is a function of a size of memory read for at least one of the input/output operations on the block of data during the time period.

8. The method in accordance with claim 1, wherein the act of assigning a demand value for at least one of the plurality of time periods comprises an act of assigning a demand value that is a function a pattern of the input/output operations on the block of data during the time period.

9. The method in accordance with claim 1,
wherein the block of data comprises a portion of a file when the file is larger than a particular size.

10. The method in accordance with claim 9, wherein the block of data comprises an entire file when the file is at below the particular size.

11. The method in accordance with claim 1, wherein the plurality of time periods are included within a plurality of groups of time periods, wherein the assigned demand values for each of a plurality of time periods within an oldest group of time periods is discarded from being included in the act of calculating the accumulated demand for the block of data once the oldest group of the time periods is above a certain age.

12. The method in accordance with claim 1, wherein the act of calculating an accumulated demand for the block of data weighs an assigned demand value for an older period of time more lightly at least in one case than an assigned demand value for a younger period of time.

13. The method in accordance with claim 12, wherein the act of calculating an accumulated demand applies a discrete reduction function so that assigned demand values for time periods before an instant in time weighs less that assigned demand values for time periods after the instant in time.

14. The method in accordance with claim 12, wherein the act of calculating an accumulated demand applies a decaying function to the assigned demand for a given time period so that the assigned demand weighs less and less into the calculated accumulated demand as time moves forward.

15. The method in accordance with claim 1, wherein the act of calculating an accumulated demand for the block of data associated with a given point in time by using the accumulated demand statistics comprises:
an act of accessing prior accumulated statistics associated with a prior point in time just prior to the given point in time;
an act of obtaining the assigned demand value for a most recent time period in the plurality of time periods; and
an act of calculating the accumulated demand as a function of the prior accumulated statistics and the assigned demand value for the most recent time period in the plurality of time periods.

16. The method in accordance with claim 15, wherein the act of calculating an accumulated demand for the block of data associated with a given point in time by using the accumulated demand statistics further comprises:
an act of offsetting the accumulated demand to account for removal of an oldest time period in the plurality of time periods.

17. The method in accordance with claim 1, wherein one level of the storage hierarchy is flash memory, mechanical disk, solid-state disk, byte addressable memory, and dynamic random access memory.

18. The method in accordance with claim 1, wherein the method is performed within a file system of a computing system.

19. A computer program product comprising one or more computer-readable storage media having thereon computer-executable instructions that are structured such that, when executed by one or more processors of a computing system, cause the computing system to perform a method for positioning a block of data within a storage hierarchy, the method comprising:
an act of identifying a block of data;
an act of accumulating demand statistics for the block of data over a plurality of time periods by performing the following for each of the plurality of time periods:
an act of evaluating input/output operations on the block of data during the time period;
an act of assigning a demand value to the time period based on the act of evaluating input/output operations on the block of data during the time period;
an act of calculating an accumulated demand for the block of data associated with a given point in time by using the accumulated demand statistics;
an act of determining a level in a storage hierarchy to store the block of data based on the calculated accumulated demand for the block of data; and
an act of positioning in the block of data in the determined level of the storage hierarchy.

20. A system comprising:
a storage hierarchy comprising at least a first level and a second level;
a demand calculation mechanism configured to perform the following for each of a plurality of blocks of data for a plurality of periods of time:
an act of accumulating demand statistics for the block of data over a plurality of time periods by performing the following for each of the plurality of time periods:
an act of evaluating input/output operations on the block of data during the time period;
an act of assigning a demand value to the time period based on the act of evaluating input/output operations on the block of data during the time period;
an act of calculating an accumulated demand for the block of data associated with a given point in time by using the accumulated demand statistics;
an eviction promotion component configured to perform the following for the plurality of blocks of data:
an act of determining a level in a storage hierarchy to store the block of data based on the calculated accumulated demand for the block of data; and
an act of positioning in the block of data in the determined level of the storage hierarchy.
